(19) United States
(12) Patent Application Publication
(10) Pub. No.: US 2017/0032381 A1
(43) Pub. Date: Feb. 2, 2017

(54) SYSTEM AND METHOD FOR DETECTING COUNTERFEITING PRODUCT USING ENCRYPTION AND DECRYPTION METHODOLOGIES

(71) Applicant: ANAND VAIDYANATHAN, CHENNAI (IN)

(72) Inventor: ANAND VAIDYANATHAN, CHENNAI (IN)

(21) Appl. No.: 15/088,140

(22) Filed: Apr. 1, 2016

(30) Foreign Application Priority Data
Jul. 28, 2015 (IN) 3870/CHE/2015

(51) Int. Cl. G06Q 30/00; G06F 21/60; G06K 7/14; G06K 19/06; G06F 17/30

(52) U.S. Cl. CPC G06Q 30/0185; G06K 19/06037; G06F 17/30876; G06K 7/1404; G06F 21/602; G06Q 2220/00

(57) ABSTRACT

A system for detecting counterfeiting product includes a server that generates a unique serial number and communicates the unique serial number to a computing device. The system further includes an encryption module that encrypts the unique serial number and converts into a QR code. The computing device communicates the QR code to a packaging machine to print the QR code and the unique serial number on the product's label. The system further includes a decryption module that decrypts the QR code into the unique serial number and compares with the serial number on the product to detect the counterfeit product. The unique serial number is communicated to the server to verify the unique serial number. The server communicates the unique serial number to an analytics engine to detect counterfeit product. The analytics engine detects and confirms whether the product is original using an analytics algorithm.

### BACKGROUND

Technical Field

The embodiments herein generally relate to counterfeiting product detection, and, more particularly, a system and method for detecting counterfeiting product using encryption and decryption methodologies.

Description of the Related Art

In the consumer goods industry, counterfeiting is a significant and growing problem. While Pharmaceutical, Cosmetics, fashion and luxury goods have long been targets of counterfeiters, nearly any branded product can be the subject of counterfeiting. For example, products such as shampoo, automotive parts, baby formula and even beer have been the subjects of counterfeiting. Counterfeiting is difficult to detect, investigate, and quantify. Consequently, it is difficult to know the full extent of the problem. However, by some estimates, between five to seven percent of all world trade is in counterfeit goods. That figure is likely to increase as globalization continues and supply chains are extended further into developing countries that lack the ability and/or the desire to detect and prevent counterfeiting.

In a traditional counterfeiting scheme, an individual or group of individuals, produces, packages and attempts to sell products with the intent to deceptively represent the product's authenticity and/or source. In most cases, the quality of a counterfeit is less than the original product that the counterfeit has been designed to emulate. Consequently, consumers that unknowingly purchase counterfeit goods are being defrauded. In some cases, such as with drugs, medicines and automotive parts, when a consumer unknowingly purchases a counterfeit, the results can be dire.

Counterfeiting has a significant impact on business entities as well. Perhaps the most obvious negative effect counterfeits have on companies is lost revenue and profit. Less obvious but equally important is the potential damage counterfeits can cause to a company's brand equity. For example, a single highly publicized negative incident caused by the use of a counterfeit can cause immeasurable damage to a company's reputation.

Several techniques have been developed or proposed for preventing counterfeiting. For example, some of the techniques aimed at preventing counterfeiting include marking products, color shifting inks, tamper labels, intaglio inks, and ultraviolet inks. However, this approach is often ineffective because the identifying mark is easily copied by counterfeiters, and/or is too difficult for consumers to recognize.

Accordingly, there remains a need for a system and method for detecting counterfeiting product using encryption and decryption methodologies.

### SUMMARY

In view of the foregoing, an embodiment herein provides a system for detecting counterfeiting product using encryption and decryption methodologies. The system includes a memory unit, and a processor. The memory unit that stores (a) a set of modules, and (b) a database. The processor which executes the set of modules. The set of modules includes a serial number receiving module, a serial number encryption module, a QR code communication module, a QR code scanning module, a QR code decryption module, a serial number comparison module, a serial number verification module, and a confirmation module. The serial number receiving module, executed by the processor, configured to receive a unique serial number along with an alphanumeric check string from a server. The serial number encryption module, executed by the processor, configured to encrypt the unique serial number using an encryption keys/private key and an encryption algorithm. The encrypted unique serial number is converted into a customized quick response (QR) code using a symmetric or an asymmetric encryption. The QR code communication module, executed by the processor, configured to communicate the encrypted QR code to a packaging machine. The packaging machine prints (a) the QR code, and (b) the unique serial number on a label. The QR code scanning module, executed by the processor, configured to scan the QR code from (a) a product, (b) a secondary package, or (c) a tertiary package. The QR code decryption module, executed by the processor, configured to decrypt (a) the QR code of the product, (b) the QR code of the secondary package, or (c) the QR code of the tertiary package into an original unique serial number. The serial number comparison module, executed by the processor, configured to compare the unique serial number decrypted by the QR code decryption module with the unique serial number printed in (a) the product, (b) the secondary package, or (c) the tertiary package to detect the counterfeit product. (a) the product, (b) the secondary package, or (c) the tertiary package is original when the encrypted unique serial number matches (a) the product, (b) the secondary package, or (c) the tertiary package. The serial number verification module, executed by the processor, configured to communicate the decrypted unique serial number to the server. The confirmation module, executed by the processor, configured to provide a confirmation message whether (a) the product, (b) the secondary package, or (c) the tertiary package is original.

In one embodiment, the server (a) generates the unique serial number, (b) communicates the unique serial number to a computing device through a secure network, (c) generates private keys/public keys and communicates the private keys/public keys to a first user and an end user, and (d) receives the unique serial number from the serial number verification module, (e) communicates the unique serial number to an analytics engine. In another embodiment, the analytics engine detects whether check is valid and (a) the product, (b) the secondary package, or (c) the tertiary package is original using an analytics algorithm. In yet another embodiment, the packaging machine prints the label (a) on the product, (b) on the secondary package that contains one or more products, or (c) on the package that contains one or more secondary package. In yet another embodiment, the serial number verification module, executed by the processor, further configured to communicate the decrypted unique serial number to the server along with GPS coordinates/details of an end user device when the QR code scanned from (a) the primary package, (b) the secondary package, or (c) the tertiary package. In yet another embodiment, the customized QR code/RFID code includes the unique serial number in an encrypted form. In yet another embodiment, the packaging machine tags radio frequency identification (RFID) tag to the tertiary package. The RFID tag includes (a) details of the tertiary package, and (b) one or more details/aggregation of the secondary package. In yet another embodiment, the QR code decryption module receives a decryption public key from the server to read and decipher/decrypt the QR code into the unique serial number.

In another aspect, a system for detecting counterfeiting product using encryption and decryption methodologies is provided. The system includes a memory unit, and a processor. The memory unit that stores (a) a set of modules, and (b) a database. The processor which executes the set of modules. The set of modules includes a serial number receiving module, a serial number encryption module, a QR code communication module, a QR code scanning module, a QR code decryption module, a serial number comparison module, a serial number verification module, and a confirmation module. The serial number receiving module, executed by the processor, configured to receive a unique serial number along with an alphanumeric check string from a server. The serial number encryption module, executed by the processor, configured to encrypt the unique serial number using an encryption private key and an encryption algorithm. The encrypted unique serial number is converted into a customized quick response (QR) code using a symmetric or an asymmetric encryption. The QR code communication module, executed by the processor, configured to communicate the encrypted QR code to a packaging machine. The packaging machine prints (a) the QR code, and (b) the unique serial number on a label. The QR code scanning module, executed by the processor, configured to scan the QR code from (a) a product, (b) a secondary package, or (c) a tertiary package. The QR code decryption module, executed by the processor, configured to decrypt (a) the QR code of the product, (b) the QR code of the secondary package, or (c) the QR code of the tertiary package into a original unique serial number. The serial number comparison module, executed by the processor, configured to compare the unique serial number decrypted by the QR code decryption module with the unique serial number printed in (a) the product, (b) the secondary package, or (c) the tertiary package to detect the counterfeit product. When the unique serial number is matches (a) the product, (b) the secondary package, or (c) the tertiary package is original. The serial number verification module, executed by the processor, configured to communicate the decrypted unique serial number to the server. The serial number verification module communicates the decrypted unique serial number to the server along with a GPS coordinates and other details of an end user device when the QR code scanned from (a) the secondary package, or (b) the tertiary package. The confirmation module, executed by the processor, configured to provide a confirmation message whether (a) the product, (b) the secondary package, or (c) the tertiary package is original. The confirmation module communicates (a) the product name, (b) company name, (c) batch date, (d) manufacture date, (e) expiry date, and (f) the check string corresponding to the unique serial number to an end user device. The QR code decryption module includes a decryption public key to read and decipher/decrypt the QR code into the unique serial number.

In one embodiment, the packaging machine prints the label on (i) the product, (ii) the secondary package, and (iii) the tertiary package by a peel-away configuration or a scratch to reveal configuration. The peel-away configuration makes the QR code unavailable to dumpster divers or counterfeiters. The peel-away configuration separates the QR code from the unique serial number when an end user opens the product. In another embodiment, the packaging machine prints the label on apparel using a water soluble ink. The apparel is washed, the QR code dissolves preventing misuse from counterfeiters when the apparel is finally discarded after cycles of use. In yet another embodiment, the packaging machine prints a first label, and a second label on the product. The first label and the second label are peel off separately and not be found together to preventing misuse of the first label and the second label from dumpster divers or counterfeiters. In yet another embodiment, the first label and the second label includes (a) the unique serial number, and (b) the QR code respectively. In yet another embodiment, the packaging machine prints the label on the product using an air reactant ink. The QR code reacts with air and disappears before end of cycle of use of the product when open the product. In yet another embodiment, the serial number comparison module includes (i) an optical character reader to read an optical character, and (ii) a bar code reader to read a 1-D bar code. The optical character and said 1-D bar code is automatically compared with the decrypted QR code using the data capturing and comparison technologies.

In yet another aspect, a method for detecting counterfeiting product is provided. The method includes the following steps: (i) receiving, using a serial number receiving module, a unique serial number along with an alphanumeric check string from a server; (ii) encrypting, using a serial number encryption module, the unique serial number into a quick response (QR) code using a symmetric or asymmetric encryption; (iii) communicating, using a QR code communication module, the encrypted QR code to a packaging machine; (iv) scanning, using a QR code scanning module, the QR code from (i) a primary package, (ii) a secondary package, or (iii) a tertiary package; (v) decrypting, using a QR code decryption module, (i) the QR code of the product, (ii) the QR code of the secondary package, or (iii) the QR code of the tertiary package into a original unique serial number; (vi) comparing, using a serial number comparison module, the unique serial number decrypted by the QR code decryption module with the unique serial number printed in (i) the primary package, (ii) the secondary package, or (iii) the tertiary package to detect a counterfeit product; (vii) communicating, using a serial number verification module, the decrypted unique serial number to the server; (viii) detecting, using the serial number verification module, whether a check is valid and (i) the product, (ii) the secondary package, or (iii) the tertiary package is original using an analytics algorithm; and (ix) providing, using a confirmation module, a confirmation message whether (i) the product, (ii) the secondary package, or (iii) the tertiary package is original. In one embodiment, the customized QR code includes the unique serial number in an encrypted form.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of assigning a label to a product and detecting an counterfeiting product using encryption and decryption methodologies according to an embodiment herein;

FIG. 2 illustrates an exploded view of a counterfeit product detection system of FIG. 1 according to an embodiment herein;

FIGS. 3A and 3B are flow diagrams illustrating a method of detecting a counterfeit product using encryption and decryption methodologies of FIG. 1 according to an embodiment herein;

FIG. 4 illustrates an exploded view of a personal communication device according to the embodiments herein; and

FIG. 5 a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned, there remains a need for a system and method for detecting counterfeiting product using encryption methodologies. A server generates a unique serial number and communicates a unique serial number to a computing device through a secure network. In one embodiment the serial numbers can be generated in a process called serialization where unique pseudo random numbers are generated. An encryption module encrypts the unique serial number. In one embodiment, the symmetric or asymmetric encryption may be employed to encrypt the unique serial number. The encrypted unique serial number is converted into a customized quick response (QR) code. The computing device communicates the QR code and the unique serial number to a packaging machine. The packaging machine prints the QR code and the unique serial number along with a check string to a label. The packaging machine prints the label on the product by a peel-away configuration or a scratch to reveal configuration. The printed product is shipped to a distributor, retailer and then to the end user. In one embodiment, the end user device may be a mobile that includes an application. The mobile application includes a decryption module to decrypt the QR code using a decryption algorithm and a public key provided by the server. The decryption module includes a decryption public key to read and decipher/decrypt the QR code into the original unique serial number. The decryption module reads and decrypts the QR code into the original unique serial number. The decrypted serial number is compared with the serial number on the label. If a match is found the product can be said to be original. The comparison part may be automated where an OCR (Optical Character Reader) can read the unique serial number and then a comparison with the decrypted QR code can be done. In one embodiment, the unique serial number can be 1-D bar code which can be read by a reader. In a secondary check the unique serial number can be communicated to the server where the unique serial number is verified if the check has been done before. The server communicates the unique serial number to an analytics engine which can then ascertain in case of multiple checks whether the package is just being rechecked through suitable algorithms. The analytics engine hence detects and confirms whether the check is valid and the product is original using an analytics algorithm. It then reports it back to the user on his App.

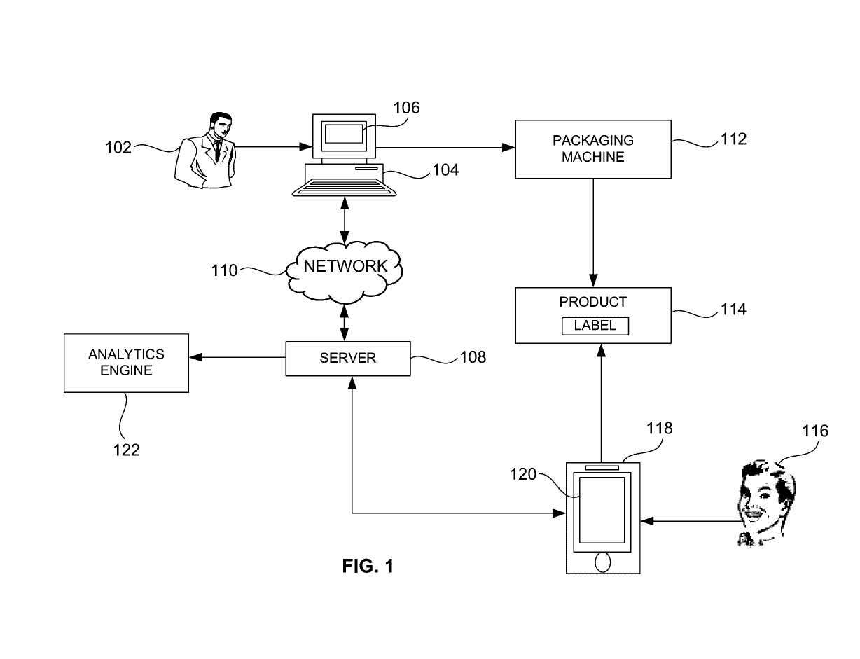

Referring now to the drawings, and more particularly to FIGS. 1 through FIG. 5, where similar reference characters denote corresponding features consistently throughout the figures, there are shown preferred embodiments.

FIG. 1 illustrates a system view 100 of assigning a label to a product 114 and detecting a counterfeiting product using encryption and decryption methodologies according to an embodiment herein. The system view 100 includes a first user 102, an computing device 104, a server 108, a secure network 110, a packaging machine 112, a product 114, a second user 116, an end user device 118, and a analytics engine 122. The computing device 104 includes an encryption module 106. The first user 102 interacts with the computing device 104 to receive a unique serial number along with an alphanumeric check string from the server 108 for each product. In one embodiment, the computing device 104 may be a personal computer, or a laptop. The server 108 generates the unique serial number and communicates the unique serial number to the computing device 104 through the secure network 110. In one embodiment, the server 108 generates a unique serial number for each product. In one embodiment, the server 108 generates private keys/public keys and communicates said private keys/public keys to a first user and an end user. The encryption module 106 encrypts the unique serial number. The encryption may be done using symmetric or asymmetric encryption. In one embodiment, the encryption module 106 encrypts the unique serial number using an encryption private key and an encryption algorithm. The encrypted unique serial number is then converted into a customized QR code. In one embodiment, the computing device 104 converts the encrypted unique serial number is converted into a customized QR code.

In one embodiment, the asymmetric encryption generates the QR code with a private key. In another embodiment, the private key is assigned by the server 108. In yet another embodiment, the encryption module 106 performs the symmetric or asymmetric encryption based on the level of security required. The computing device 104 communicates the QR code to the packaging machine 112. The packaging machine 112 prints the QR code and the unique serial number to a label. In one embodiment, the QR code includes the unique serial number in an encrypted form. The packaging machine 112 prints/paste the label to the product 114. In one embodiment, the label includes the QR code, and the unique serial number. The packaging machine 112 prints the label (i) on the product 114 (i.e. primary packaging), (ii) on the box level (i.e. secondary packaging) that contains one or more products, and (iii) on the tertiary level (i.e. tertiary packaging) that contains one or more secondary package. In one embodiment, the label is printed on the product 114, or the box level in a hidden from view. In one embodiment the packaging machine 112 tags a radio frequency identification (RFID) tag to the tertiary package. In one embodiment, the RFID tag includes details of the secondary package (e.g. unique serial numbers of the secondary package), and the place to where the tertiary package needs to transit. The unique serial numbers of the one or more products is grouped as a batch under the serial number of the secondary package. The unique serial number of the secondary package is grouped under the RFID tag of the tertiary package. In one embodiment, the unique serial number can be 1-D bar code.

The packaging machine 112 prints the label on (i) the product 114, (ii) the secondary package, and (iii) the tertiary package using a peel-away configuration or a scratch to reveal configuration. The peel-away configuration makes the QR code unavailable to dumpster divers or counterfeiters who use unverified and discarded QR codes for reuse. In the peel-away configuration, when the end user 116 opens the package to use the product 114, the QR code comes off with the package to separate the QR code from the unique serial number. The unique serial number on the product 114 is separated from the QR code and prevents the QR code reuse by dumpster divers. The separation of the QR Code and the unique serial number prevents the counterfeiters from getting hold of both together with intention of copying the unique serial number. In a Wash-away variation, the packaging machine 112 prints the QR tag on apparel using a water soluble ink. The QR tag displays the QR code and can be checked for authenticity against the unique serial number. Once the apparel is washed, the QR code dissolves preventing misuse by counterfeiters when the apparel is finally discarded after cycles of use. In a Dual-Peel away variation, the packaging machine 112 prints the two label (i.e. a first label, and a second label) on the product 114 (e.g. shoe). The first label includes a unique serial number. The second label includes a QR code. The first label and the second label is stuck next to each other to read together and a check for authenticity. When the product is to be used the end user 116 naturally peels away the first label and the second label so that the product 114 is free of the visible labels. The labels (i.e. the first label, and the second label) are separately peeled off and are not be found together to preventing the misuse of the labels (i.e. the first label, and the second label) by dumpster divers or counterfeiters. In Air-Reactant variation, the QR code is printed in an ink on the product 114. Initially the packaging is such that the QR code is sealed from air. When opens the product 114, the QR code is exposed to the air. The QR code reacts with the air and disappears before the end of cycle of use of the product 114. In Air-Reactant variation, when discarding the product 114, the product 114 does not contain a legible QR code preventing misuse.

The printed product 114 is shipped to the second user 116 after printing the QR code (i.e. a label). In one embodiment, the second user 116 may be a distributor, a retailer, or a customer. The second user 116 checks the product 114 to identify a counterfeit product using the decryption module 120. The end user device 118 includes a decryption module 120 to decrypt the QR code using a decryption algorithm. In one embodiment, the end user device 118 may be a mobile phone, a smart phone, a tablet, and etc. The second user 116 communicates with the decryption module 120 through the end user device 118 to decrypt the QR code into the unique serial number. The decryption module 120 includes a decryption public key to read and decipher/decrypt the QR code into the original unique serial number. The decryption key is provided to the decryption module 120 through an update on an application on the end user device 118. In one embodiment, the encryption module 106, and the decryption module 120 may be an application.

For example, the distributor checks the tertiary and secondary package to track the product 114. The distributor scans the QR Code/RFID tag using the decryption module 120 of the end user device 118. The decryption module 120 reads and decrypts the QR code/RFID of the tertiary package into the original unique serial number and communicates the unique serial number to the server 108 along with the GPS coordinates and other details (e.g. device type, location of the device, serial number of the device, and etc) of the end user device 118. In one embodiment, the server 108 includes the database to store a unique serial number and a QR code of the product 114, a unique serial number and the QR code of the secondary package, the RFID tag details, and the check string of the product 114. The server 108 communicates the unique serial number along with the GPS coordinates of the end user device 118 to the analytics engine 122 to track the tertiary package. The analytics engine 122 detects and confirms whether the check is valid and the product 104 is original using an analytics algorithm. In one embodiment, the RFID tag includes details of the tertiary package and one or more details/aggregation of the secondary package.

For example, the retailer/distributor checks the secondary package to detect the counterfeit product. The retailer scans the QR code and the unique serial number using the decryption module 120 of the end user device 118. The decryption module 120 reads and decrypts the QR code of the secondary package into the original unique serial number. In primary detection, the retailer compares the unique serial number decrypted by the decryption module 120 with the unique serial number printed in the secondary package to detect the counterfeit product. If the unique serial number is matches the product 114 is original. In secondary detection, the decryption module 120 communicates the decrypted unique serial number to the server 108 along with the GPS coordinates of the end user device 118 to check the counterfeit product by the decryption module 120. The server 108 communicates the unique serial number along with the GPS coordinates of the end user device 118 to the analytics engine 122 to detect the counterfeit product. The analytics engine 122 detects and confirms whether the check is valid and the secondary package (i.e. the one or more products) is original using the analytics algorithm. In one embodiment, the server 108 communicates the whether the product is original or counterfeit along with (i) product name, (ii) company name, (iii) batch date, (iv) manufacture date, (v) expiry date, and (vi) the check string corresponding to the unique serial number. In another embodiment, the check string should match the label in the secondary package.

For example, the customer checks the primary package (i.e. the product 114) to detect the counterfeit product. The customer scans the QR code and the unique serial number using the decryption module 120 of the second end user device 118. The decryption module 120 reads and decrypts the QR code of the primary package into the original unique serial number. The customer compares the unique serial number decrypted by the decryption module 120 with the unique serial number printed in the primary package to detect the counterfeit product. If the unique serial number is matches the product 114 is original. The decryption module 120 communicates the decrypted unique serial number to the server 108 to check the counterfeit product by the decryption module 120. The server 108 communicates the unique serial number to the analytics engine 122 to detect the counterfeit product. The analytics engine 122 detects and confirms whether the check is valid and the product 104 is original using the analytics algorithm. In one embodiment, the server 108 communicates the whether the product is original or counterfeit along with (i) product name, (ii) company name, (iii) batch date, (iv) manufacture date, (v) expiry date, and (vi) the check string corresponding to the unique serial number. In another embodiment, the check string should match the label in the primary/secondary package.

In one embodiment, the QR code includes a version number and a company code of encryption which the decryption module 120 recognizes during decryption. The encryption key and the decryption key is changed and communicated to the first user device 104 while the up gradation of the encryption module 106, and the decryption module 120. In one embodiment, the RFIDs and radio frequency readers are used instead of the QR code for detecting the counterfeit product. In another embodiment, the unique serial number is pseudo random generated code.

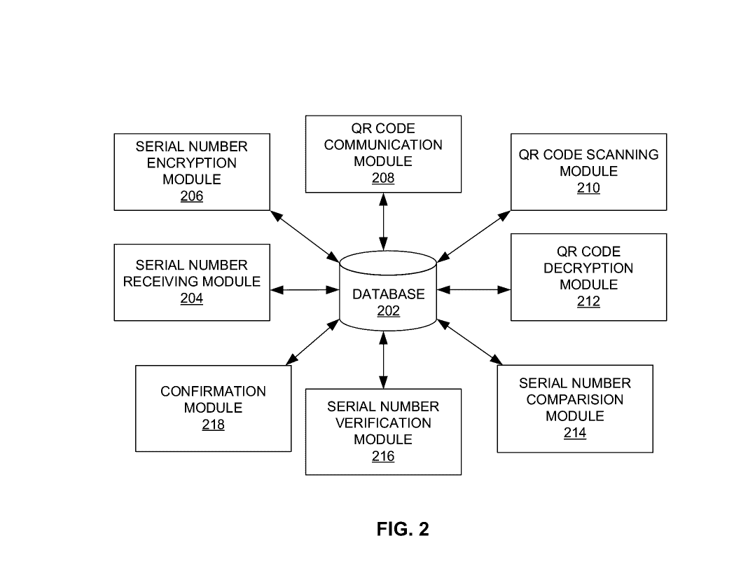

FIG. 2 illustrates an exploded view of a counterfeit product detection system of FIG. 1 according to an embodiment herein. The counterfeit product detection system includes a database 202, a serial number receiving module 204, a serial number encryption module 206, a QR code communication module 208, a QR code scanning module 210, a QR code decryption module 212, a serial number comparison module 214, a serial number verification module 216, and a confirmation module 218. The database 202 includes a unique serial number for the product 114, a QR code for the product 114, a unique serial number for a secondary package, a RFID tag details (i.e. a unique serial number and a QR code for the tertiary package), product name, company name, batch date, manufacture date, expiry date, and the check string corresponding to the unique serial number. The serial number receiving module 204 is configured to receive a unique serial number along with an alphanumeric check string from the server 108 for each product. The server 108 generates the unique serial number and communicates the unique serial number to the computing device 104 through the secure network 110. In one embodiment, the server 108 generates a unique serial number for each product. The serial number encryption module 206 is configured to encrypt the unique serial number using an encryption private key/key and an encryption algorithm. The serial number encryption module 206 converts the encrypted unique serial number into a customized quick response (QR) code using a symmetric or an asymmetric encryption. The QR code communication module 208 is configured to communicate the encrypted QR code to the packaging machine 112. In one embodiment, the packaging machine 112 prints the QR code and the unique serial number on the label. The packaging machine 112 print/paste the label (i) on the product 114 (i.e. primary packaging), (ii) on the box level (i.e. secondary packaging) that contains one or more products, or (iii) on the tertiary level (i.e. tertiary packaging) that contains one or more secondary package. The QR code scanning module 210 is configured to scan the QR code from (i) the product 114 (i.e. primary packaging), (ii) the box level (i.e. secondary packaging), or (iii) the tertiary level (i.e. tertiary packaging). The QR code decryption module 212 is configured to decrypt (i) the QR code of the product 114, (ii) the QR code of the secondary package, or (iii) the QR code of the tertiary package into the original unique serial number. The QR code decryption module 212 receives decryption public key/keys from the server 108 to read and decipher/decrypt the QR code into the original unique serial number. The serial number comparison module 214 is configured to compare the unique serial number decrypted by the QR code decryption module 212 with the unique serial number printed in (i) the primary package, (ii) the secondary package, or (iii) the tertiary package to detect the counterfeit product. If the unique serial number is matches the product 114 is original. In one embodiment, the second user 116 compares the unique serial number decrypted by the QR code decryption module 212 with the unique serial number printed in (i) the primary package, (ii) the secondary package, or (iii) the tertiary package to detect the counterfeit product. The serial number comparison module 214 is configured to compare the decrypted QR code with the unique serial number on (i) the product (i.e. primary package), (ii) the secondary package, or (iii) the tertiary package using various data capturing and comparison technologies and detects whether there is a match. When a unique serial number and the QR code matches (i) the product (i.e. primary package), (ii) the secondary package, or (iii) the tertiary package is genuine/original. In one embodiment, the serial number comparison is a primary test. In one embodiment, the serial number comparison module 214 includes (i) an optical character reader to read an optical character, and (ii) a bar code reader to read a 1-D bar code. The optical character and the 1-D bar code is automatically compared with the decrypted QR code using the data capturing and comparison technologies. The serial number verification module 216 is configured to communicate the decrypted unique serial number to the server 108. In one embodiment, the serial number verification module 216 communicate the decrypted unique serial number to the server 108 along with the GPS coordinates of the end user device 118 when the QR code scanned from (i) the secondary package, or (iii) the tertiary package. The server 108 receives and communicates the unique serial number to the analytics engine 122 to detect the counterfeit product. In one embodiment, the server 108 communicates the unique serial number along with the GPS coordinates of the end user device 118 to the analytics engine 122 when the QR for (i) the secondary package, or (iii) the tertiary package. The analytics engine 122 detects whether the check is valid and (i) the product 114, (ii) the secondary package, or (iii) the tertiary package is original using the analytics algorithm. The confirmation module 216 is configured to provide a confirmation message whether (i) the product 114, (ii) the secondary package, or (iii) the tertiary package is original. The confirmation module 216 is further configured to communicate the (i) the product name, (ii) company name, (iii) batch date, (iv) manufacture date, (v) expiry date, and (vi) the check string corresponding to the unique serial number to the end user device 118.

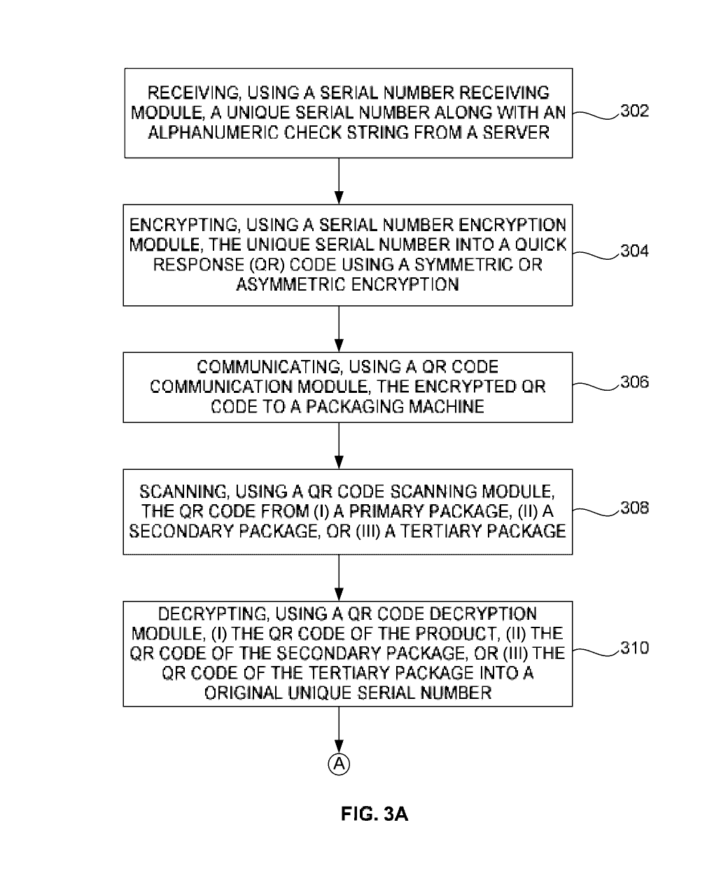

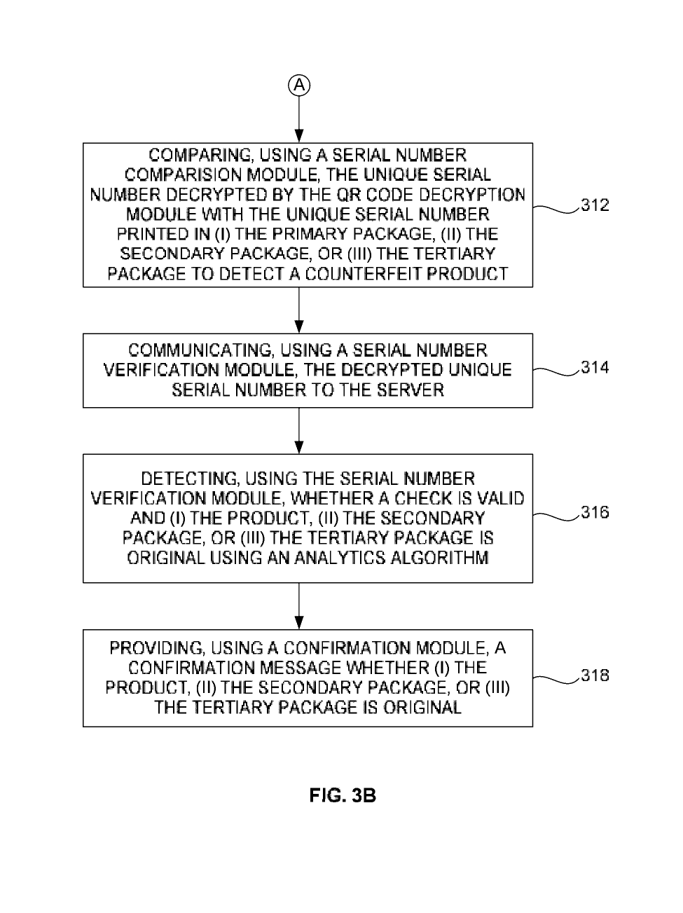

FIGS. 3A and 3B are flow diagrams illustrating a method of detecting a counterfeit product using encryption and decryption methodologies of FIG. 1 according to an embodiment herein. At step 302, the first user 102 interacts with the computing device 104 to receive a unique serial number along with an alphanumeric check string from the server 108 for each product. The server 108 generates the unique serial number and communicates the unique serial number to the computing device 104 through the secure network 110. At step 304, the encryption module 106 encrypts the unique serial number into a quick response (QR) code using a symmetric or asymmetric encryption. The encryption module 106 encrypts the unique serial number into a quick response (QR) code using an encryption key and an encryption algorithm. In one embodiment, the asymmetric encryption generates the QR code with a private key. In another embodiment, the encryption module 106 performs the symmetric or asymmetric encryption based on the level of security required. At step 306, the computing device 104 communicates the QR to the packaging machine 112. The packaging machine 112 prints the QR code and the unique serial number to a label. The packaging machine 112 prints the label (i) on the product 114 (i.e. primary packaging), (ii) on the box level (i.e. secondary packaging) that contains one or more products, and (iii) on the tertiary level (i.e. tertiary packaging) that contains one or more secondary package. In one embodiment, the label includes the QR code, and the unique serial number. At step 308, the decryption module 120 scans the QR code from (i) the product 114 (i.e. primary packaging), (ii) the box level (i.e. secondary packaging), or (iii) the tertiary level (i.e. tertiary packaging). At step 310, the decryption module 120 decrypts (i) the QR code of the product 114, (ii) the QR code of the secondary package, or (iii) the QR code of the tertiary package into the original unique serial number. The second user 116 compares the unique serial number decrypted by the QR code decryption module 212 with the unique serial number printed in (i) the primary package, or (ii) the secondary package to detect the counterfeit product. At step 312, the second user 116 compares the unique serial number decrypted by the QR code decryption module 212 with the unique serial number printed in (i) the primary package (i.e. the product 114), (ii) the secondary package, or (iii) the tertiary package to detect the counterfeit product. In one embodiment, (i) the primary package (i.e. the product 114), (ii) the secondary package, or (iii) the tertiary package is original when the unique serial number is matches (i) the primary package (i.e. the product 114), (ii) the secondary package, or (iii) the tertiary package in a primary check. In another embodiment, comparison may be done through an automated process using data capturing and comparing technologies. At step 314, the decryption module 120 communicates the decrypted unique serial number to the server 108. In one embodiment, the decryption module 120 communicate the decrypted unique serial number to the server 108 along with the GPS coordinates of the end user device 118 when the QR code scanned from (i) the primary package (i.e. the product 114), (ii) the secondary package, or (iii) the tertiary package. The server 108 receives and communicates the unique serial number to the analytics engine 122 to detect the counterfeit product. In one embodiment, the server 108 communicates the unique serial number along with the GPS coordinates of the end user device 118 to the analytics engine 122 when the QR code scanned from (i) the primary package (i.e. the product 114), (ii) the secondary package, or (iii) the tertiary package. At step 316, the analytics engine 122 detects whether the check is valid and (i) the product 114, (ii) the secondary package, or (iii) the tertiary package is original using the analytics algorithm. At step 318, the analytics engine 122 provides a confirmation message whether (i) the product 114, (ii) the secondary package, or (iii) the tertiary package is original to the end user device 118 along with (i) product name, (ii) company name, (iii) batch date, (iv) manufacture date, (v) expiry date, and (vi) the check string corresponding to the unique serial number. In one embodiment, the analytics engine 122 provides the confirmation message to the end user device 118 through the server 108.

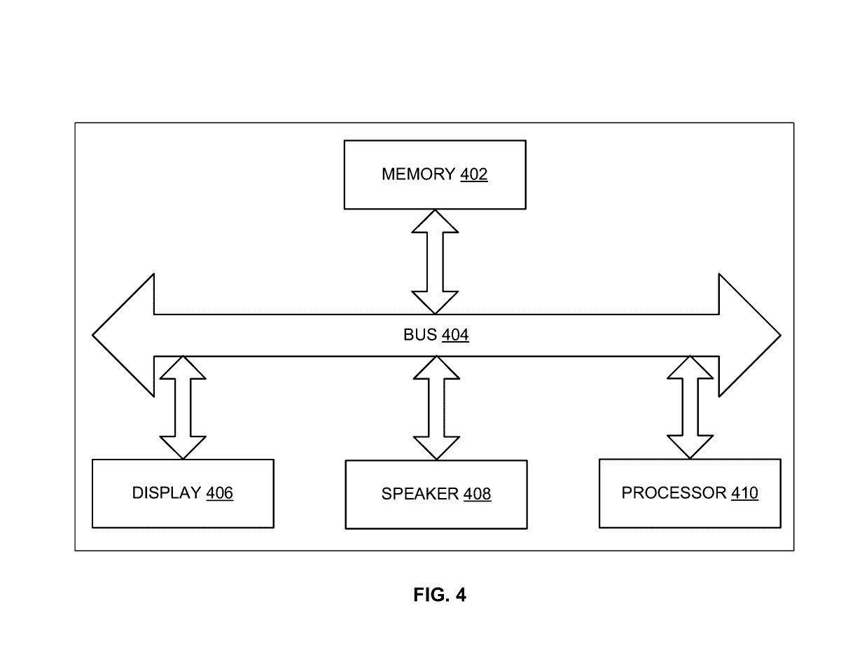

FIG. 4 illustrates an exploded view of the personal communication device having an a memory 402 having a set of computer instructions, a bus 404, a display 406, a speaker 408, and a processor 410 capable of processing a set of instructions to perform any one or more of the methodologies herein, according to an embodiment herein. In one embodiment, the receiver may be the personal communication device. The processor 410 may also enable digital content to be consumed in the form of video for output via one or more displays 406 or audio for output via speaker and/or earphones 408. The processor 410 may also carry out the methods described herein and in accordance with the embodiments herein.

Digital content may also be stored in the memory 402 for future processing or consumption. The memory 402 may also store program specific information and/or service information (PSI/SI), including information about digital content (e.g., the detected information bits) available in the future or stored from the past. A user of the personal communication device may view this stored information on display 406 and select an item of for viewing, listening, or other uses via input, which may take the form of keypad, scroll, or other input device(s) or combinations thereof. When digital content is selected, the processor 410 may pass information. The content and PSI/SI may be passed among functions within the personal communication device using the bus 404.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

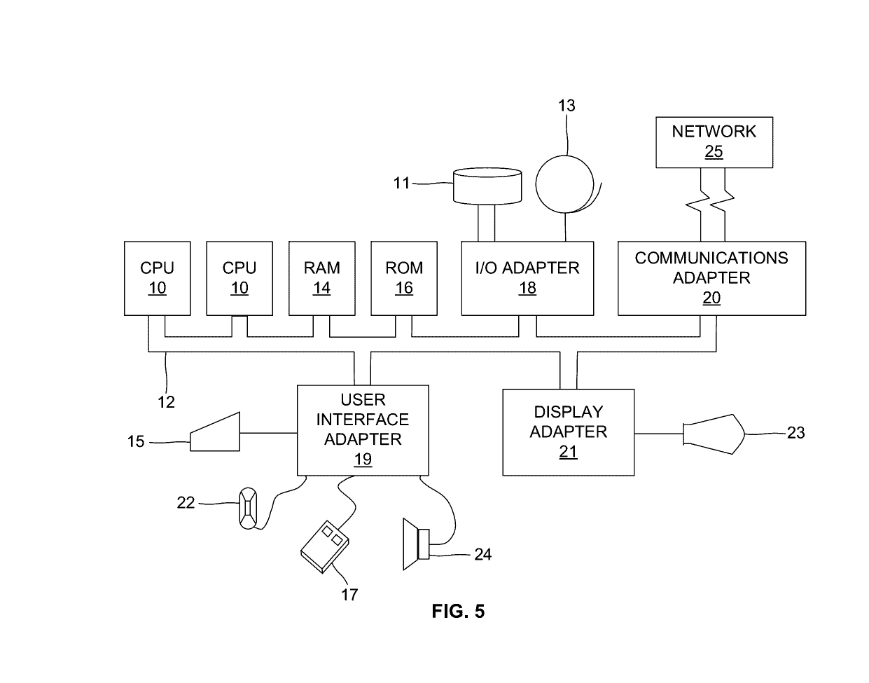

A representative hardware environment for practicing the embodiments herein is depicted in FIG. 5. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The application (i.e. the encryption module 106 and the decryption module 120) additionally provides the following features: (i) patient monitoring, (ii) reminders for timely intake of medicines, and (iii) advice on dosage and dissipation of medical information to patients regarding ailments. The counterfeit product detection system allows the end user to check the quality of the product. The counterfeit product detection system prevents the counterfeit product manufacturing in cost effective manner. The counterfeit product detection system prevents the revenue leaks. The counterfeit product detection system is easy to implement and the counterfeit product detection system performed through the mobile applications. No internet connection is needs to confirm whether product is counterfeit. The chance of a false positive is greatly reduced by eliminating random number guesses of serial numbers. The check string prevents the counterfeit product from the Counterfeiter when the Counterfeiter swamps the system with random serial numbers.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for detecting counterfeiting product using encryption and decryption methodologies comprising:
(i) a memory unit that stores (a) a set of modules, and (b) a database; and
(ii) a processor which executes said set of modules, wherein said set of modules comprise:
a serial number receiving module, executed by said processor, configured to receive a unique serial number along with an alphanumeric check string from a server;
a serial number encryption module, executed by said processor, configured to encrypt said unique serial number using an encryption keys/private key and an encryption algorithm, wherein said encrypted unique serial number is converted into a customized quick response (QR) code using a symmetric or an asymmetric encryption;
a QR code communication module, executed by said processor, configured to communicate said encrypted QR code to a packaging machine, wherein said packaging machine prints (a) said QR code, and (b) said unique serial number on a label;
a QR code scanning module, executed by said processor, configured to scan said QR code from (a) a product, (b) a secondary package, or (c) a tertiary package;
a QR code decryption module, executed by said processor, configured to decrypt (a) said QR code of said product, (b) said QR code of said secondary package, or (c) said QR code of said tertiary package into an original unique serial number;
a serial number comparison module, executed by said processor, configured to compare said unique serial number decrypted by said QR code decryption module with said unique serial number printed in (a) said product, (b) said secondary package, or (c) said tertiary package to detect said counterfeit product, wherein (a) said product, (b) said secondary package, or (c) said tertiary package is original when said encrypted unique serial number matches (a) said product, (b) said secondary package, or (c) said tertiary package;
a serial number verification module, executed by said processor, configured to communicate said decrypted unique serial number to said server; and
a confirmation module, executed by said processor, configured to provide a confirmation message whether (a) said product, (b) said secondary package, or (c) said tertiary package is original.

2. The system as claimed in claim 1, wherein said server (a) generates said unique serial number, (b) communicates said unique serial number to a computing device through a secure network, (c) generates private keys/public keys and communicates said private keys/public keys to a first user and an end user, (d) receives said unique serial number from said serial number verification module, and (e) communicates said unique serial number to an analytics engine.

3. The system as claimed in claim 2, wherein said analytics engine detects whether check is valid and (a) said product, (b) said secondary package, or (c) said tertiary package is original using an analytics algorithm.

4. The system as claimed in claim 1, wherein said packaging machine prints said label on (a) said product, (b) said secondary package that contains one or more products, or (c) said tertiary package that contains one or more secondary package.

5. The system as claimed in claim 1, wherein said serial number verification module, executed by said processor, further configured to communicate said decrypted unique serial number to said server along with GPS coordinates/details of an end user device when said QR code scanned from (a) said primary package, (b) said secondary package, or (c) said tertiary package.

6. The system as claimed in claim 1, wherein said customized QR code/RFID code comprises said unique serial number in an encrypted form.

7. The system as claimed in claim 1, wherein said packaging machine tags radio frequency identification (RFID) tag to said tertiary package, wherein said RFID tag comprises (a) details of said tertiary package, and (b) one or more details/aggregation of said secondary package.

8. The system as claimed in claim 1, wherein said QR code decryption module receives a decryption public key from said server to read and decipher/decrypt said QR code into said unique serial number.

9. A system for detecting counterfeiting product using encryption and decryption methodologies comprising:
(i) a memory unit that stores (a) a set of modules, and (b) a database; and
(ii) a processor which executes said set of modules, wherein said set of modules comprise:
a serial number receiving module, executed by said processor, configured to receive a unique serial number along with an alphanumeric check string from a server;
a serial number encryption module, executed by said processor, configured to encrypt said unique serial number using an encryption private key and an encryption algorithm, wherein said encrypted unique serial number is converted into a customized quick response (QR) code using a symmetric or an asymmetric encryption;
a QR code communication module, executed by said processor, configured to communicate said encrypted QR code to a packaging machine, wherein said packaging machine prints (a) said QR code, and (b) said unique serial number on a label;
a QR code scanning module, executed by said processor, configured to scan said QR code from (a) a product, (b) a secondary package, or (c) a tertiary package;
a QR code decryption module, executed by said processor, configured to decrypt (a) said QR code of said product, (b) said QR code of said secondary package, or (c) said QR code of said tertiary package into a original unique serial number;
a serial number comparison module, executed by said processor, configured to compare said unique serial number decrypted by said QR code decryption module with said unique serial number printed in (a) said product, (b) said secondary package, or (c) said tertiary package to detect said counterfeit product, wherein when said unique serial number is matches (a) said product, (b) said secondary package, or (c) said tertiary package is original;
a serial number verification module, executed by said processor, configured to communicate said decrypted unique serial number to said server, wherein said serial number verification module communicates said decrypted unique serial number to said server along with a GPS coordinates of an end user device when said QR code scanned from (a) said secondary package, or (b) said tertiary package; and
a confirmation module, executed by said processor, configured to provide a confirmation message whether (a) said product, (b) said secondary package, or (c) said tertiary package is original, wherein said confirmation module communicates (a) said product name, (b) company name, (c) batch date, (d) manufacture date, (e) expiry date, and (f) said check string corresponding to said unique serial number to said end user device,
wherein said QR code decryption module comprises a decryption public key to read and decipher/decrypt said QR code into said unique serial number.

10. The system as claimed in claim 9, wherein said packaging machine print said label on (i) said product, (ii) said secondary package, and (iii) said tertiary package by a peel-away configuration or a scratch to reveal configuration, wherein said peel-away configuration makes said QR code unavailable to dumpster divers or counterfeiters, wherein said peel-away configuration separates said QR code from said unique serial number when said end user opens said product.

11. The system as claimed in claim 9, wherein said packaging machine prints said label on apparel using a water soluble ink, wherein said apparel is washed, said QR code dissolves use.

12. The system as claimed in claim 9, wherein said packaging machine prints a first label, and a second label on said product, wherein said first label and said second label are peel off separately and not be found together to preventing misuse of said first label and said second label from dumpster divers or counterfeiters.

13. The system as claimed in claim 12, wherein said first label and said second label comprises (a) said unique serial number, and (b) said QR code respectively.

14. The system as claimed in claim 9, wherein said packaging machine prints said label on said product using an air reactant ink, wherein said QR code reacts with air and disappears before end of cycle of use of said product when open said product.

15. The system as claimed in claim 9, wherein said serial number comparison module comprises (i) an optical character reader to read an optical character, and/or (ii) a bar code reader to read a 1-D bar code, wherein said optical character, and/or said 1-D bar code is automatically compared with said decrypted QR code using data capturing and comparison technologies.

16. A method for detecting counterfeiting product comprising:
receiving, using a serial number receiving module, a unique serial number along with an alphanumeric check string from a server;
encrypting, using a serial number encryption module, said unique serial number into a quick response (QR) code using a symmetric or asymmetric encryption;
communicating, using a QR code communication module, said encrypted QR code to a packaging machine;
scanning, using a QR code scanning module, said QR code from (i) a primary package, (ii) a secondary package, or (iii) a tertiary package;
decrypting, using a QR code decryption module, (i) said QR code of said product, (ii) said QR code of said secondary package, or (iii) said QR code of said tertiary package into a original unique serial number;
comparing, using a serial number comparison module, said unique serial number decrypted by said QR code decryption module with said unique serial number printed in (i) said primary package, (ii) said secondary package, or (iii) said tertiary package to detect a counterfeit product;
communicating, using a serial number verification module, said decrypted unique serial number to said server;
detecting, using said serial number verification module, whether a check is valid and (i) said product, (ii) said secondary package, or (iii) said tertiary package is original using an analytics algorithm; and
providing, using a confirmation module, a confirmation message whether (i) said product, (ii) said secondary package, or (iii) said tertiary package is original.

17. The method as claimed in claim 16, wherein said customized QR code comprises said unique serial number in an encrypted form.
